(19) United States
(12) Patent Application Publication
(10) Pub. No.: US 2026/0010708 A1
(43) Pub. Date: Jan. 8, 2026

(54) DOCUMENT GENERATION SYSTEM AND METHOD

(71) Applicant: RentPackage Co., Ltd., Zhubei City (TW)

(72) Inventor: CHING-JU HSIEH, Zhubei City (TW)

(21) Appl. No.: 18/765,425

(22) Filed: Jul. 8, 2024

(51) Int. Cl. G06F 40/174; G06F 3/0484; G06F 40/186

(52) U.S. Cl. CPC G06F 40/174; G06F 3/0484; G06F 40/186

(57) ABSTRACT

A document generation system and method of the present disclosure can provide the document creator with creating a document easily and assigning each field of the document to a corresponding data filling user, such that it achieves the purpose of allowing multiple users to collaboratively input data to generate a collaborative document. It also allows the document creator to modify the document content in real time. In addition, the collaborative documents generated above can documents of various types, such as contracts, forms, or even Gantt charts. That is, the document generation system and method of the present disclosure have a wide range of applications. Even the document creator can operate and use the document generation system and method of the present disclosure without having any knowledge of program development, which reduces the creation or development time for creating documents of various types and developing databases.

### BACKGROUND

### Technical Field

The present disclosure relates to a document generation system and method, and in particular to a document generation system and method which provides multiple users with collaboratively inputting data to generate a collaborative document, and specifically, the document generation system and method provides the document creator with tagging or marking field on one or more places of the document to be edited and assigning a data filling user to input data in the field, such that the data of the field which is tagged or marked on one or more places of the document to be edited can be stored in a data base.

### Related Art

A document generation system for generating a document has been widely seen in daily life. Usually, a document generation system provides the user with creating and editing a document via a software as a service (SaaS). The document generation systems provided by existing manufacturers only have contract generation functions or form generation functions but cannot provide contract generation functions and form generation functions at the same time. In addition, if the same data needs to appear in multiple locations within a contract or form, the user must repeat to fill data, causing inconvenience. On the other hand, the contracts generated by the document generation system are usually in a non-editable portable file format documents. Therefore, the document content cannot be modified in real time by the creator, and the contract completely relies on the document creator to input data.

When the document generation system provided by existing manufacturer generates the document, though the document generation system stores data in a database, these data are not defined as meaningful data (for example: store the field name and data type in a database; store and define the data structure and data name in XML; store and define the KEY value and corresponding VALUE of the data in JSON; or store in NoSQL method). Without knowing the content of the stored data, the database cannot allow users to meaningfully access and browse the data. In addition, although some manufacturers provide a form generation system that can specify a data filling user to fill data in the form, this form generation system cannot specify multiple data filling users, nor can it specify the field to the data filling user who needs to fill the data in the field. Generally speaking, the existing document generation system still needs to be further improved to provide multiple users with collaboratively inputting data in corresponding fields to generate a collaborative document.

### SUMMARY

To solve the problems in the prior art, the present disclosure provides a document generation system, and the document generation system provides multiple users with collaboratively inputting data to generate a collaborative document. The document generation system comprises a server, wherein the server is used to communicate with at least one communication devices of the users and generate the collaborative document. The generation of the collaborative document is illustrated as follows. The server provides a first user of the users with creating a first document, wherein a first operation interface which the server provides for the first user has a field selection area, the field selection area provides the first user with tagging or marking at least one field of the field selection area on one or more places of the first document of a word processing area in the first operation interface, the field is at least assigned with a field name, and can be further assigned with a data type, a text length and so on. When the first user tags or marks the field on the one or more places of the first document, the first user can set a data filling user property of the field in the word processing area, and the first user can further set a required property of the field, wherein the data filling user property represents a data filling user, and the data filling user is a second user of the users. Further, the first user can set data filling user priority of the first document in the word processing area. The server at least stores the first document, the data filling user property of the field and the one or more places of the first document on which the field is tagged or marked in a form storage, the server can further store the data filling user priority flag and required property in the form storage, the server at least stores the field name of the field in a field storage, and the server can further store the data type and the text length of the field in the field storage. The server generates a second document and provides the second user with a second operation interface, wherein the second operation interface displays the second document, the displayed second document represents a document content of the first document and the field which is tagged or marked on the one or more places of the first document, the second operation interface further provides the second user with inputting data in the field which is tagged or marked on the one or more places of the first document, and the server stores the data of the field in a data layer storage. The server integrates the first document, the field which is tagged or marked on the one or more places of the first document and the data of the field to generate the collaborative document to the first user and the second user.

To solve the problems in the prior art, the present disclosure provides a document generation method, the document generation method is executed in a server which is communicated with at least one of communication devices of users, and the document generation method comprises the following steps: the server provides a first user of the users with creating a first document, wherein a first operation interface which the server provides for the first user has a field selection area, the field selection area provides the first user with tagging or marking at least one field of the field selection area on one or more places of the first document of a word processing area in the first operation interface, the field is at least assigned with a field name, and can be further assigned with a data type, a text length and so on, when the first user tags or marks the field on the one or more places of the first document, the first user can set a data filling user property of the field in the word processing area, and the first user can further set a required property of the field, wherein the data filling user property represents a data filling user, and the data filling user is a second user of the users; the server at least stores the first document, the data filling user property of the field and the one or more places of the first document on which the field is tagged or marked in a form storage, the server can further store the data filling user priority flag and required property in the form storage, the server at least stores the field name of the field in a field storage, and the server can further store the data type and the text length of the field in the field storage; the server generates a second document and provides the second user with a second operation interface, wherein the second operation interface displays the second document, the displayed second document represents a document content of the first document and the field which is tagged or marked on the one or more places of the first document, the second operation interface further provides the second user with inputting data in the field which is tagged or marked on the one or more places of the first document, and the server stores the data of the field in a data layer storage; and the server integrates the first document, the field which is tagged or marked on the one or more places of the first document and the data of the field to generate the collaborative document to the first user and the second user.

To sum up, the document generation system and method provided by the present disclosure can provide the document creator with easily creating a document, and each field of the document can be assigned to a corresponding data filling user, such that it can achieve the objective that users can collaboratively input data for generating a collaborative document, and the document creator can edit or modify the content of the document in real time. Further, the collaborative document generated above can be one of documents of various types, such as a contract, a form, or even a Gantt chart. That is, the document generation system and method of the present disclosure have a wide range of applications. Even the document creator can operate and use the document generation system and method of the present disclosure to create the document without having any knowledge of program development, database architecture, and etc., and the data can be input into the database through the generated document. That is to say, the creation or development time required to create documents of various type and develop database programs is reduced.

### BRIEF DESCRIPTIONS OF DRAWINGS

The accompanying drawings are included to provide a further understanding of the present disclosure and are incorporated in and constitute a part of this specification. The drawings illustrate exemplary embodiments of the present disclosure and, together with the descriptions, serve to explain the principles of the present disclosure.

FIG. 1 is a block diagram showing a document generation system according to one embodiment of the present disclosure.

FIG. 2 is a flow chart of a document generation method according to one embodiment of the present disclosure.

FIG. 3 to FIG. 10 are schematic diagrams showing multiple operation interfaces provided by a document generation system or method according to embodiments of the present disclosure.

### DETAILS OF EXEMPLARY EMBODIMENT

To understand the technical features, content and advantages of the present disclosure and its efficacy, the present disclosure will be described in detail with reference to the accompanying drawings. The drawings are for illustrative and auxiliary purposes only and may not necessarily be the true scale and precise configuration of the present disclosure. Therefore, the scope of the present disclosure should not be limited to the scale and configuration of the attached drawings. Further, it is noted the term “filling data in a field” and “inputting data in a field” are the same as each other in some scenario.

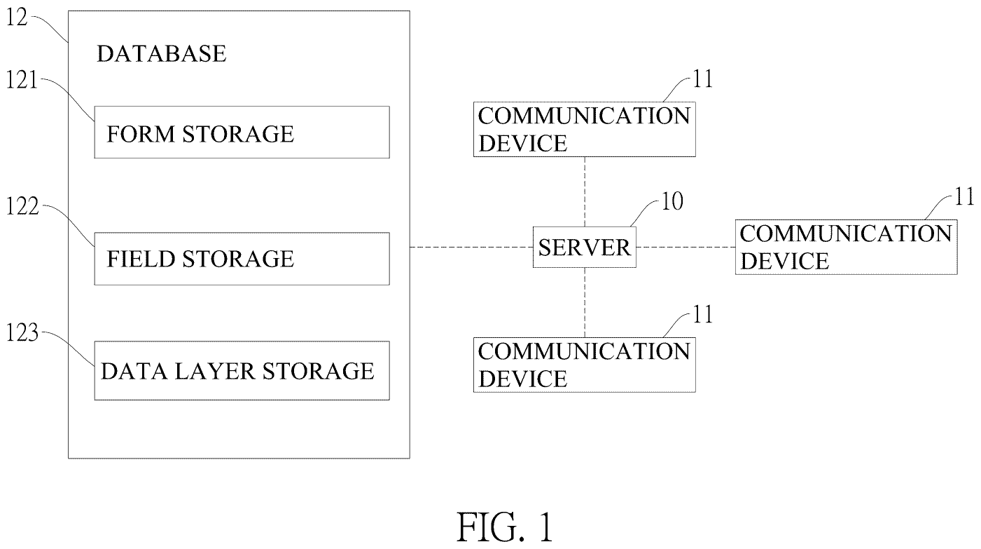

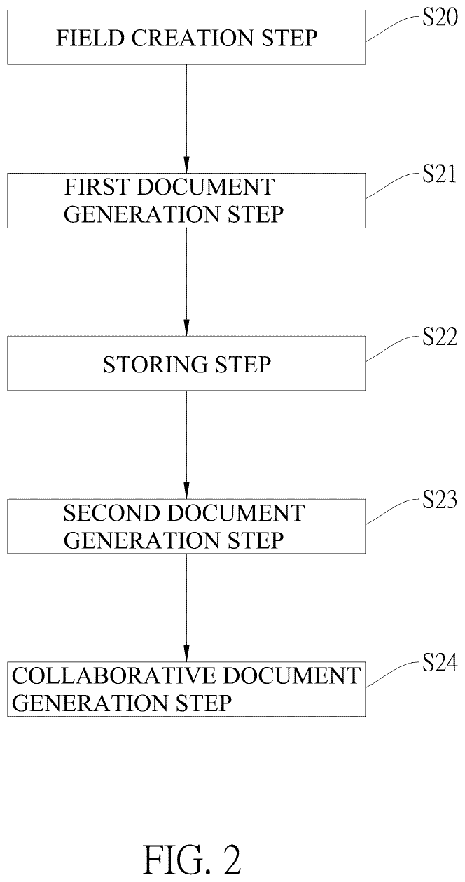

Refer to FIG. 1, and FIG. 1 is a block diagram showing a document generation system according to one embodiment of the present disclosure. The document generation system comprises a server 10, the server 10 are used to communicate with at least one communication devices 11 of the users and a database 12. The database 12 can be divided to three storages, which are respectively a form storage 121, a field storage 122 and a data layer storage 123. In the embodiment, the number of the communication devices 11 is three, and the number of the users is three, but the present disclosure is not limited thereto. In one embodiment, the numbers of the communication devices 11 and the users are more than two, and in another one embodiment, there is only one communication device 11 which each user can use the communication device 11 to input data in the field corresponding to the user. The main objective of the document generation system provided by the present disclosure is to allow the users to collaboratively input data to generate a collaborative document, and the document generation system executes the document generation method of FIG. 2.

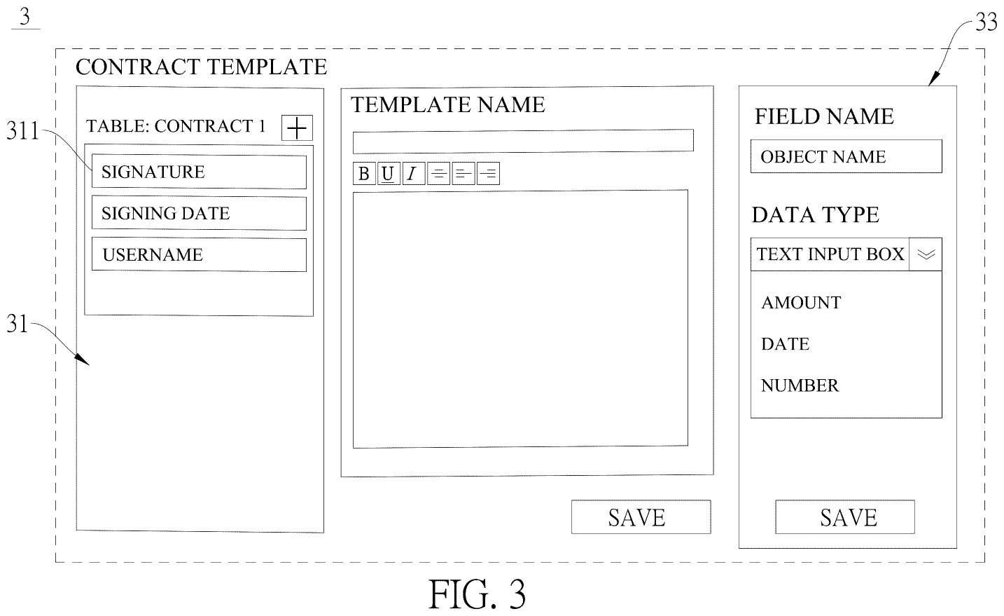

Refer to FIG. 1 to FIG. 3, FIG. 2 is a flow chart of a document generation method according to one embodiment of the present disclosure, and FIG. 3 is a schematic diagram showing an operation interface provided by a document generation system or method according to one embodiment of the present disclosure. Firstly, at a field creation step S20, the server provides the first user of the users with creating one or more fields 311 in the field selection area 31, for example, the first user can press “+” button in the field selection area 31 to create a field 311, the first user can set the field name and the data type of the field 311 in the field setting area 33, and the server 10 can store the field name and the data type of the field 311 in the field storage 122, such that the first user can select one or more fields 311 in the field selection area 31. In addition to the field name and the data type of the field 311, the properties of the field can further comprise the text length, and the server 10 can further store the text length of the field 311 in the field storage 122. Next, at a first document generation step S21, the server 10 provides the first user of the users with creating a first document, wherein the a first operation interface 3 which the server 10 provides for the first user has the field selection area 31, the field selection area 31 provides the first user with tagging or marking at least one field 311 of the field selection area 31 on one or more places of the first document of a word processing area 32 in the first operation interface 3. At the same time, the first user needs to set the a data filling user property of the field 311, for example, the word processing area 32 can show a selection blank (not shown in FIG. 3) for the first user to select the data filling user, the data filling user property represents the data filling user, and the data filling user is a second user of the users. Further, at the first document generation step S21, when the first user tags or marks the field 311 on the one or more places of the first document of a word processing area 32, the first user can further optionally set the required property of the field 311, the required property defines the data filling user must input the data in the corresponding field 311 which is tagged or marked on the one or more places of the first document. By the way, when the field 311 of the field selection area 31 is selected by the first user, and the data filling user property of the field 311 tagged or marked on the one or more places of the first document is set, the field 311 tagged or marked on the one or more places of the first document can be represented by a specific color, wherein the different data filling users correspond to different specific colors.

It is noted that, if the communication device 11 operated by the first user is the computer or notebook, the first user can use the mouse or touch pad to drag the field 311 of field selection area 31 on the one or more places of the first document of a word processing area 32, so as to tag or mark the field 311 of the field selection area 31 on the one or more places of the first document of the word processing area 32. If the communication device 11 operated by the first user is the smart phone or pad without the mouse and touch pad, the first user can firstly touch the field 311 to be selected by using a finger or touch pen (i.e., pressing the field 311 to be selected), and then touches one place of the first document of a word processing area 32 in the first operation interface 3 to tag or mark the field 311 of the field selection area 31 on the one or more places of the first document of the word processing area 32 (i.e., pressing the place of the first document on which the field 311 to be tagged or marked). If the field 311 should be tagged or marked on more places of the first document of the word processing area 32, the above touch operation for selection and the above touch operation for placing must be executed several times.

Specifically, the first document created by the first user can be a blank document, or the first user can open an existing or template document as the created first document, and the first document can be edited by the first user. It is noted that the type of the first document is not limited thereto. The field 311 can be pre-defined or preset by the first user. In the first operation interface 3, the field selection area 31 can display the corresponding field 311 of at least one data filling user according to the option of the first user. Further, the second user can usually be a user other than the first user, but also can be the first user in some conditions. For example, when signing the contract, the first user and the user other than the first user will need to input data in the field 311.

In FIG. 3, the field selection area 31 displays the fields 311 with the field names of “signature”, “signing date” and “username”. The field setting area 33 provides the first user with setting the field name and the data type of the field 311. There is one activatable control button at the bottom of the field setting area 33 (for example, “save” button at the bottom of the field setting area 33), and the first user can click or touch such button to make the server 10 store the field name and the data type of the field 311 in the field storage 122. The field selection area 31 not only can provide the user with tagging or marking the field 311 on the one or more places of the first document, but also can provide the first user with adding a new field 311. For example, there is a “+” button in the field selection area 31 which can be touched or clicked by the first user for adding a new field 311. There is one activatable control button at the bottom of the word processing area 32 (for example, the “save” button at the bottom of the word processing area 32), and the first user can click or touch such button to make the server 10 store the data filling user property and the required property of the field 311 and the data filling user priority flag in the form storage 121.

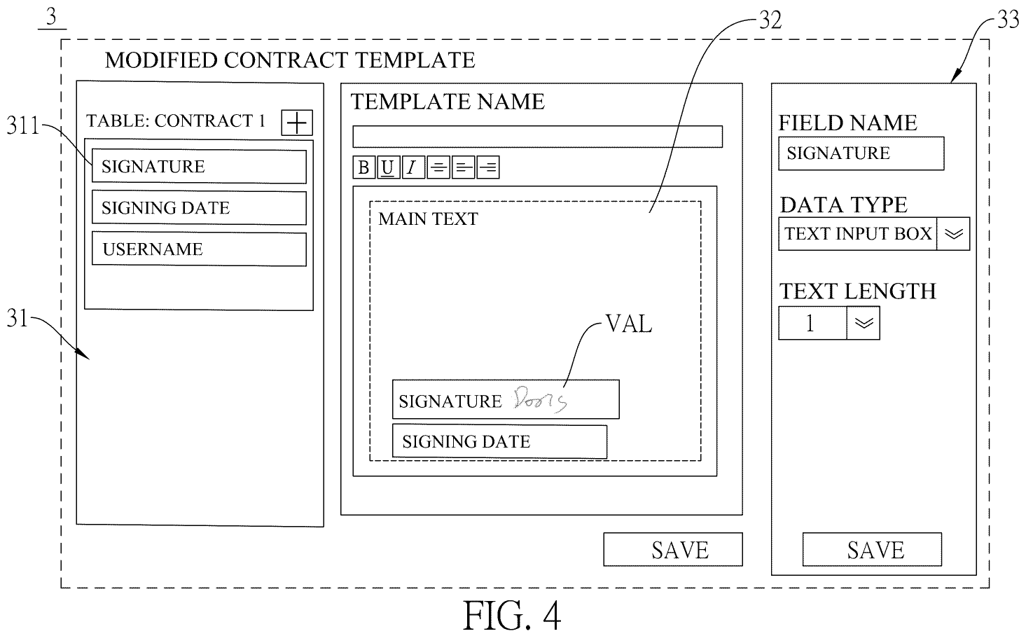

In addition, referring to FIG. 4, FIG. 4 is a schematic diagram showing another one operation interface provided by a document generation system or method according to one embodiment of the present disclosure. Being different from the first operation interface 3 of FIG. 3, the field setting area 33 in FIG. 4 further provides the first user with setting the text length of the field 311. Further, if the data is pre-input in the field, the data of the field 311 will displayed on the corresponding places of the first document on which the field 311 is tagged or marked on. For example, the signature image VAL is pre-input in the field 311 which is tagged or marked on a specific place of the first document of the word processing area 32, and the preview content of the first document of the word processing area 32 seen by the first user displays the signature image VAL on the specific place of the first document.

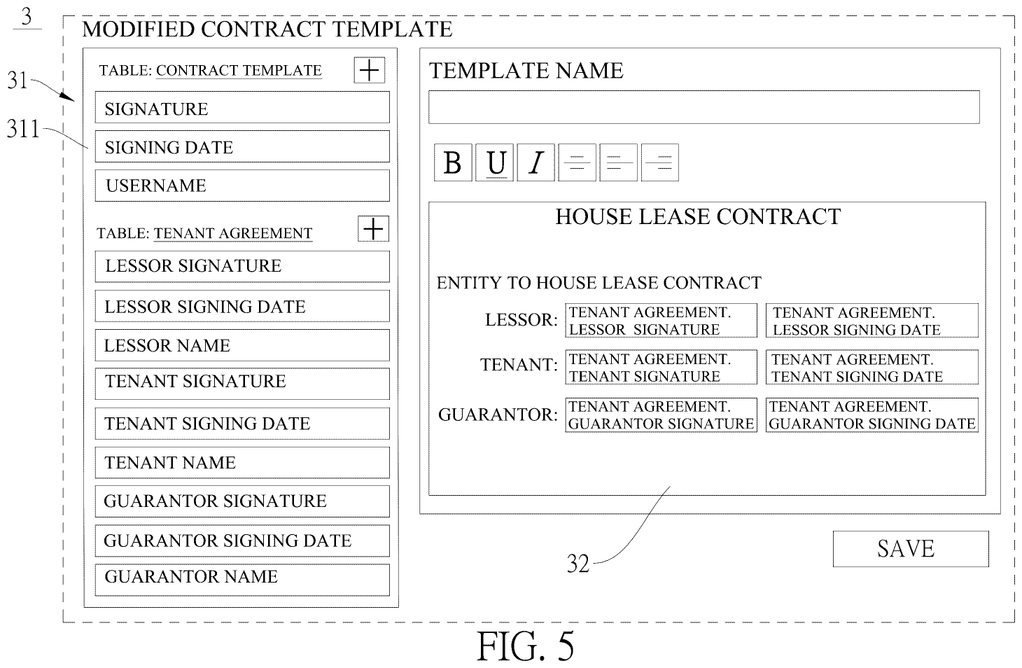

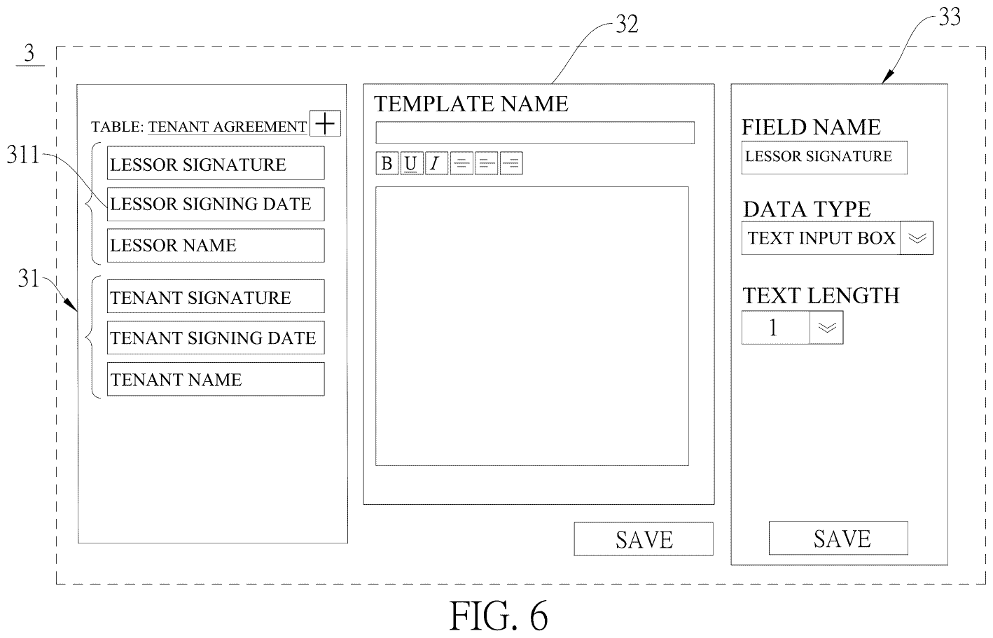

Refer to FIG. 5 and FIG. 6, FIG. 5 and FIG. 6 are schematic diagrams showing two operation interfaces provided by a document generation system or method according to embodiments of the present disclosure. Being different from the first operation interface 3 of FIG. 3 and FIG. 4, the fields 311 of the field selection area 31 in FIG. 5 and FIG. 6 are grouped into one or several tables. For example, in FIG. 5, there are two tables in the field selection area 31, the names of the two tables are “lease renewal agreement” and “tenant agreement”, and each of the tables has the multiple fields 311; and in FIG. 6, the multiple fields 311 are grouped by landlords and tenants, that is, the fields are grouped by the data filling users. In addition, the grouping manner for grouping the fields 311 may be grouping based on matters or other rules, and the present disclosure is not limited thereto.

Please still refer to FIG. 1 and FIG. 3, and the data type defines the field 311 to be a text input field, a currency input field, a number input field, a date input field, a checkbox, a radio button, an image upload field, a component adding field, a formula inputting field, a signature field, a diagram drawing selection box or an email inputting field, and the present disclosure is not limited thereto. Further, the text length of the fields 311 can be set and defined by the first user.

After the first user has finished the edition of the first document (i.e., has input the text content, tagged or marked at least one field 311 on the one or more places of the first document, and pressed the activatable control button (the “save” button) on the bottom of the word processing area 32), a storing step S22 is executed. At the storing step S22, the server 10 stores the first document, the data filling user property of the field 311 tagged or marked on the one or more places of the first document and the one or more places of the first document on which the field 311 is tagged or marked in the form storage 121. Further, at the storing step S22, the server 10 can further store the required property of the field 311 tagged or marked on the one or more places of the first document and the data filling user priority flag in the form storage 121.

Further, the document generation method provides the first user with assigning the data filling user priority for inputting data in the fields 311 which is tagged or marked on the places of the first document, and the data filling user priority can be represented by a data filling user priority flag. The data filling user priority flag can be stored in the form storage 121 as well as the first document. When the data filling user priority is assigned, the second users must fill data in the fields 311 which are tagged or marked on the places of the first document by the data filling user priority. For example, there are four fields 311 tagged or marked on the places of the first document, the first field 311 and second field 311 of the above four fields 311 are assigned to be filled in by the second user being the landlord, and the third field 311 and fourth field 311 of the above four fields 311 are assigned to be filled in by the second user being the tenant. In such example, the data of the first field 311 and second field 311 must be input by the second user being the landlord, and then the second user being the tenant is allowed to input the data in the third field 311 and fourth field 311.

It is noted that, the field 311 can be tagged or marked on multiple places of the first document of the word processing area 32, and the places of the first document on which the field 311 is tagged or marked are stored in the form storage 121. Further, the word processing area 32 is a portable document format word processing area, and the place of the first document on which the field 311 is tagged or marked represents a position tag of an upper layer of the a portable document format word processing area in a two dimensional coordinate (i.e., the position tag is a coordinate point (X,Y)), and the place which the form storage 121 stores is the position tag.

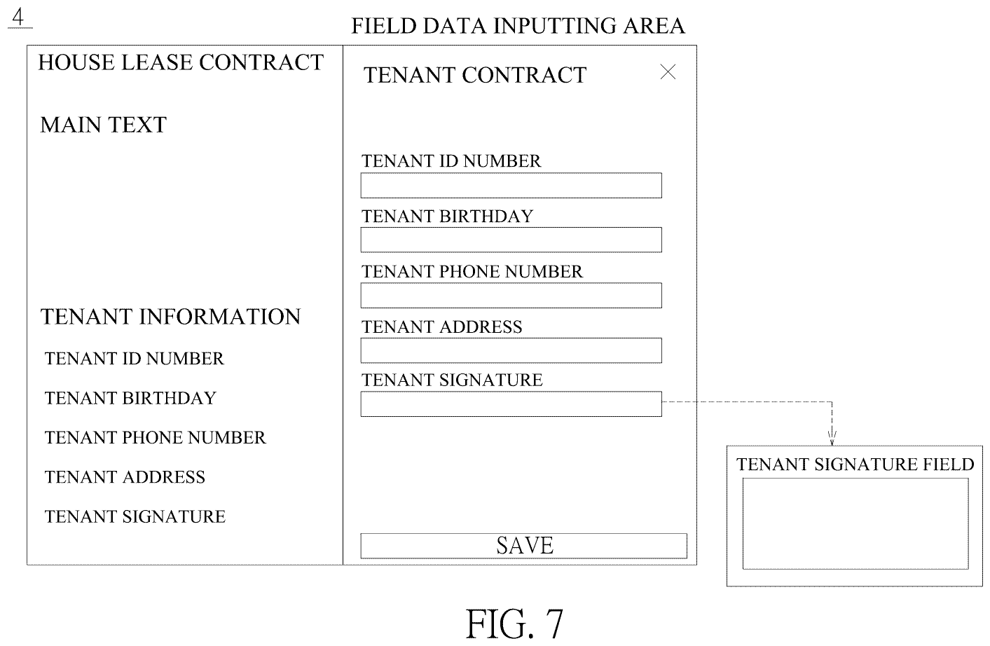

Next, refer to FIG. 1, FIG. 2 and FIG. 7, and FIG. 7 is a schematic diagram showing another operation interface provided by a document generation system or method according to one embodiment of the present disclosure. At a second document generation step S23, the server 10 generates the second document and provides the second user being the data filling user with a second operation interface 4, wherein the second operation interface 4 displays the second document, the displayed second document represents a document content of the first document (the left of the second operation interface 4 has a document display area for displaying the document content of the first document) and the field 311 which is tagged or marked on the one or more places of the first document (the right of the second operation interface 4 has a field data inputting area for displaying the field 311 in which the second user input data), and the second operation interface 4 further provides the second user with inputting data in the field 311 which is tagged or marked on the one or more places of the first document (the right of the second operation interface 4 has a field data inputting area with multiple input data boxes of the fields 311 which provide the second user with inputting data). The places of the data input boxes of the fields 311 in the second operation interface 4 are in relative to the places of the fields 311 of the first document, and the present disclosure is not limited thereto. In another embodiment, the identical place arrangement manner can be adopted, and that is, the places of the data input box of the field 311 of second document displayed in the second document display area are same as the places of the first document on which the field 311 is tagged or marked, and the data input boxes of the fields 311 provide the second user with directly inputting the data of the fields 311.

After the second user input all data, the second user can press the activatable control button of the second operation interface 4 (the “SAVE” button at right and bottom of the second operation interface 4), and then the server 10 stores the data of the field 311 in the data layer storage 123. Next, at a collaborative document generation step S24, the server 10 integrates the first document, the field 311 which is tagged or marked on the one or more places of the first document and the data of the field 311 to generate the collaborative document for the first user and the second user.

Refer to FIG. 1 again, and in the embodiment of the present disclosure, the document generation method further comprises the following steps: if the first user has checked the collaborative document is correct, the first users can operate the operation interface to make the server send the collaborative document to the first and second users by email, or send-a link of the collaborative document to the first and second users, wherein the collaborative document can be a portable document format (PDF) document; and the server 10 is configured to provide the first user and/or the second user with processing an electronic payment. For example, the collaborative document is a contract document, and the first user and the second user can proceed with subsequent signing and online payment after receiving it. Furthermore, the server 10 can also allow the first user and the second user to check the contract signing status when signing a contract. For example, the first user has signed, but the second user has not signed.

Moreover, the document generation method further comprises the following step: the server 10 provides the first user with importing a data filling user group table, each batch of data in the data filling user group table assigns one or more data filling users, such that multiple fields 311 of the field selection area 31 are assigned to the one or more data filling users of the data filling user group table to reduce the time of the first user needing to input multiple data filling users in large quantities, and the fields of the field selection area are grouped into one or more tables to allow the first user to assign the field 311 to all data filling users in a group at one time for data entry. The document generation method further comprises the following step: the server 10 provides the first user with importing a field data filling table, each batch of data in the field data filling table assigns at least one of the fields, such that the at least one of the fields of the field selection area is pre-entered with the data to reduce the time required for the second user to enter data in multiple fields, that is, at least part of the field data has been entered in advance.

For example, there are 13 new employees for registration, and 13 registration notices need to be sent to all new employees. In addition to the employee's name and EMAIL, the fields to be filled in by each person also include employee signature, employee signature date, department, salary, rank and arrival date. The employee signature and employee signature date are the fields that new employees (i.e. second users) need to fill in, so the contents of other fields can be imported and filled in by the first user after the first user tags or marks multiple fields into multiple places of the first document, thereby reducing the time that the second user inputs data in the fields and the time that the first user assigns the fields to the second users.

Further, when the first user tags or marks multiple fields 311 of the field selection area 31 on multiple places of the first document in the word processing area 32, and the data type of one of the fields 311 is defined as a formula inputting field or a diagram drawing selection box. After the second user can input the formula or select one kind of diagram, the field 311 can calculate or draw a diagram according to multiple data of the other fields 311.

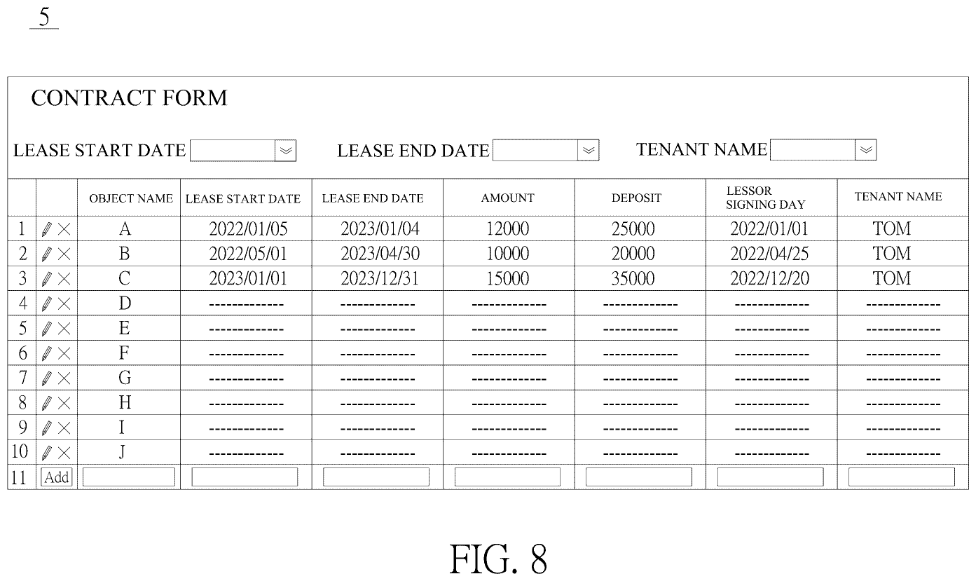

Further refer to FIG. 1 and FIG. 8, and FIG. 8 is a schematic diagram showing another one operation interface provided by a document generation system or method according to one embodiment of the present disclosure. In the embodiment of the present disclosure, the document generation method further comprises the following step: as the operation interface 5 of FIG. 8, the server 10 provides the first user or the second user with browsing, searching, performing statistics on, inserting, updating and/or deleting multiple data stored in the data layer storage 123. It is noted that, since the fields 311 are assigned field names and data types, the data stored in the field data storage 123 will become meaningful data, and duplicate data included in a contract or form document will not be stored and displayed, so that the first user or the second user can meaningfully browse, search, perform statistics on, insert, update and/or delete multiple data stored in the field data storage 123.

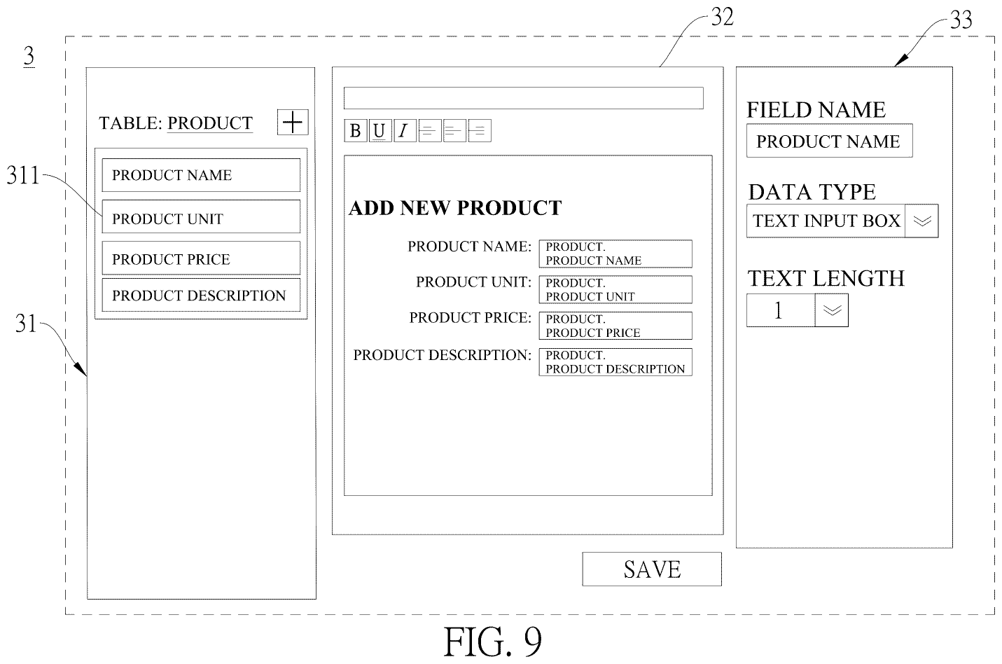

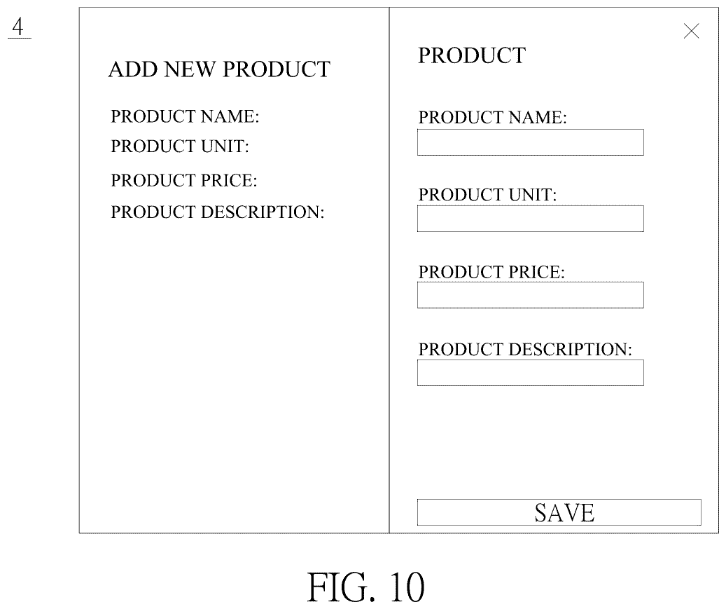

In addition, each of the first document, the second document and the collaborative document is a contract document, a purchase order document, a research and development record document, a work order document, a medical record document or a construction progress document (for example, Gantt chart), and the present disclosure is not limited thereto. Next, refer to FIG. 9 and FIG. 10, and FIG. 9 and FIG. 10 are schematic diagrams showing two operation interfaces provided by a document generation system or method according to embodiments of the present disclosure. Several operation interfaces 3 and 4 in the above embodiments are explained using contract documents as examples, but the first document and the second document corresponding to the first operation interface 3 in FIG. 9 and the second operation interface 4 in FIG. 10 are both form documents, rather than contract documents, for example, purchase order document, and the present disclosure is not limited thereto.

Accordingly, the document generation system and method provided by the present disclosure can provide the document creator with tagging or marking at least one of the fields on one or more places of the document edited in the word processing area, and assigning the field name, the data type, the data filling user property of the field, so as to generate another one document to the assigned data filling user of the users. Thus, the assigned data filling user can input the data in the field on the one or more places of the document and browse the data of the field of the document. The document generation system and method provided by the present disclosure enable multiple users to collaboratively input data to generate the collaborative document. The collaborative document can be a form or a contract document, and the data stored in the database are meaningful. Duplicate data in a contract or form document will not be stored in the database, and the database allows users to meaningfully browse, search, insert, edit or delete the data in the database. Therefore, the present disclosure can reliably solve the technical problems of the prior art, and provide multiple users with a better operating experience, and can reduce the time it takes for document creators to create documents, and without having knowledges of the program development and database architecture, the document creator can operate and use the document generation system and method of the present disclosure to create the document required by the user and add data to the required document, and can also reduce the storage space of the database and make the stored data meaningful, which facilitates the management of background data.

The foregoing summarizes the features of the embodiments of the present disclosure so that those skilled in the art can better understand aspects of the present disclosure. Those skilled in the art should appreciate that they may readily use the present disclosure as a basis for designing or modifying other processes and structures for realizing the same purposes and/or achieving the same advantages of the embodiments introduced herein. Those skilled in the art should also recognize that such equivalent constructions do not depart from the spirit and scope of the present disclosure, and that they can be variously modified, substituted, and altered herein without departing from the spirit and scope of the present disclosure.

1. A document generation system, providing multiple users with collaboratively inputting data to generate a collaborative document, comprising:
a server, used to communicate with at least one communication devices of the users, and generate the collaborative document, wherein generation of the collaborative document comprises:
the server provides a first user of the users with creating a first document, wherein a first operation interface which the server provides for the first user has a field selection area, the field selection area provides the first user with tagging or marking at least one field of the field selection area on a place of the first document of a word processing area in the first operation interface, the field is assigned with a field name and a data filling user property, the data filling user property represents a data filling user, and the data filling user is a second user of the users;
the server stores the first document, the data filling user property of the field and the place of the first document on which the field is tagged or marked in a form storage, and the server stores the field name of the field in a field storage;
the server generates a second document and provides the second user with a second operation interface, wherein the second operation interface displays the second document, the displayed second document represents a document content of the first document and the field which is tagged or marked on the place of the first document, the second operation interface further provides the second user with inputting data in the field which is tagged or marked on the place of the first document, and the server stores the data of the field in a data layer storage; and
the server integrates the first document, the field which is tagged or marked on the place of the first document and the data of the field to generate the collaborative document to the first user and the second user.

2. The document generation system of claim 1, wherein the field is further assigned with a data type and a required property, the second document is assigned with a data filling user priority flag, the data type defines the field to be a text input field, a currency input field, a number input field, a date input field, a checkbox, a radio button, an image upload field, a component adding field, a formula inputting field, a signature field, a diagram drawing selection box or an email inputting field, the data filling user priority flag defines a data filling user priority for inputting data for the first document, each of the first document, the second document and the collaborative document is a contract document, a purchase order document, a research and development record document, a work order document, a medical record document or a construction progress document, the data type of the field is stored in the field storage, and the data filling user priority flag and the required property of the field is stored in the form storage.

3. The document generation system of claim 1, wherein the server provides the first user or the second user with browsing, searching, performing statistics on, inserting, updating and/or deleting multiple data stored in the data layer storage.

4. The document generation system of claim 1, wherein the first operation interface has a first activatable control button and a second activatable control button, the second operation interface has a third activatable control button; when the first user clicks the first activatable control button, the server stores the field name and the data type of the field is stored in the field storage; when the first user clicks the second activatable control button, the server stores the first document, the data filling user property of the field and the place of the first document on which the field is tagged or marked in the form storage; the first user clicks the third activatable control button, the server stores the data of the field in the data layer storage.

5. The document generation system of claim 1, wherein the first user tags or marks multiple fields of the field selection area on multiple places of the first document in the word processing area, and one of the fields is used to calculate or draw a diagram according to multiple data of the other fields.

6. The document generation system of claim 1, wherein the server provides the first user with importing a data filling user group table, each batch of data in the data filling user group table assigns one or more data filling users, such that multiple fields of the field selection area are assigned to the one or more data filling users of the data filling user group table, and the fields of the field selection area are grouped into one or more tables, wherein the users comprises the data filling users; and/or the server provides the first user with importing a field data filling table, each batch of data in the field data filling table assigns at least one of the fields, such that-at least one of the fields of the field selection area is pre-entered with the data.

7. The document generation system of claim 1, wherein the server is configured to send the collaborative document to the first user and the second user via an email, or send a link of the collaborative document to the first user and the second user, the collaborative document is a portable document format (PDF), and the server is configured to provide the first user and/or the second user with processing an electronic payment.

8. The document generation system of claim 1, wherein the field is tagged or marked on multiple places of the first document of the word processing area, and the places of the first document on which the field is tagged or marked are stored in the form storage.

9. The document generation system of claim 1, wherein the word processing area is a portable document format word processing area, the place of the first document on which the field is tagged or marked represents a position tag of an upper layer of the portable document format word processing area in a two dimensional coordinate, and the place which the form storage stores is the position tag.

10. The document generation system of claim 1, wherein the second operation interface has a document display area for displaying the second document, the second operation interface further has a field data inputting area which provides the second user with inputting data of the field via a data input box of the field; or alternatively, a place of the data input box of the field of second document displayed in the second document display area is same as the place of the first document on which the field is tagged or marked, and the data input box of the field provides the second user with inputting the data of the field.

11. A document generation method, executed in a server which is communicated with at least one of communication devices of users, comprising:
the server provides a first user of multiple users with creating a first document, wherein a first operation interface which the server provides for the first user has a field selection area, the field selection area provides the first user with tagging or marking at least one field of the field selection area on a place of the first document of a word processing area in the first operation interface, the field is assigned with a field name and a data filling user property, the data filling user property represents a data filling user, and the data filling user is a second user of the users;
the server stores the first document, the data filling user property of the field and the place of the first document on which the field is tagged or marked in a form storage, and the server stores the field name of the field in a field storage;
the server generates a second document and provides the second user with a second operation interface, wherein the second operation interface displays the second document, the displayed second document represents a document content of the first document and the field which is tagged or marked on the place of the first document, the second operation interface further provides the second user with inputting data in the field which is tagged or marked on the place of the first document, and the server stores the data of the field in a data layer storage; and
the server integrates the first document, the field which is tagged or marked on the place of the first document and the data of the field to generate the collaborative document to the first user and the second user.

12. The document generation method of claim 11, wherein he field is further assigned with a data type and a required property, the second document is assigned with a data filling user priority flag, the data type defines the field to be a text input field, a currency input field, a number input field, a date input field, a checkbox, a radio button, an image upload field, a component adding field, a formula inputting field, a signature field, a diagram drawing selection box or an email inputting field, the data filling user priority flag defines a data filling user priority for inputting data for the first document, each of the first document, the second document and the collaborative document is a contract document, a purchase order document, a research and development record document, a work order document, a medical record document or a construction progress document, the data type of the field is stored in the field storage, and the data filling user priority flag and the required property of the field is stored in the form storage.

13. The document generation method of claim 11, further comprising:
the server provides the first user or the second user with browsing, searching, performing statistics on, inserting, updating and/or deleting multiple data stored in the data layer storage.

14. The document generation method of claim 11, wherein the first operation interface has a first activatable control button and a second activatable control button, the second operation interface has a third activatable control button; when the first user clicks the first activatable control button, the server stores the field name and the data type of the field is stored in the field storage; when the first user clicks the second activatable control button, the server stores the first document, the data filling user property of the field and the place of the first document on which the field is tagged or marked in the form storage;
the first user clicks the third activatable control button, the server stores the data of the field in the data layer storage.

15. The document generation method of claim 11, wherein the first user tags or marks multiple fields of the field selection area on multiple places of the first document in the word processing area, and one of the fields is used to calculate or draw a diagram according to multiple data of the other fields.

16. The document generation method of claim 11, further comprising:
the server provides the first user with importing a data filling user group table, each batch of data in the data filling user group table assigns one or more data filling users, such that multiple fields of the field selection area are assigned to the one or more data filling users of the data filling user group table, and the fields of the field selection area are grouped into one or more tables, wherein the users comprises the data filling users; and/or
the server provides the first user with importing a field data filling table, each batch of data in the field data filling table assigns at least one of the fields, such that the at least one of the fields of the field selection area is pre-entered with the data.

17. The document generation method of claim 11, further comprising:
the server sends the collaborative document to the first user and the second user via an email, or sends a link of the collaborative document to the first user and the second user, wherein the collaborative document is a portable document format (PDF); and
the server provides the first user and/or the second user with processing an electronic payment.

18. The document generation method of claim 11, wherein the field is tagged or marked on multiple places of the first document of the word processing area, and the places of the first document on which the field is tagged or marked are stored in the form storage.

19. The document generation method of claim 11, wherein the word processing area is a portable document format word processing area, the place of the first document on which the field is tagged or marked represents a position tag of an upper layer of the portable document format word processing area in a two dimensional coordinate, and the place which the form storage stores is the position tag.

20. The document generation method of claim 11, wherein the second operation interface has a document display area for displaying the second document, the second operation interface further has a field data inputting area which provides the second user with inputting data of the field via a data input box of the field; or alternatively, a place of the data input box of the field of second document displayed in the second document display area is same as the place of the first document on which the field is tagged or marked, and the data input box of the field provides the second user with inputting the data of the field.
